(19) United States
(12) Patent Application Publication
(10) Pub. No.: US 2008/0007120 A1
(43) Pub. Date: Jan. 10, 2008

(54) System for providing a software application for a mobile terminal in a motor vehicle

(75) Inventors: Daniel Weyl, Muenchen (DE); Karl-Ernst Steinberg, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: Bayerische Motoren Werke Aktiengesellschaft, Muenchen (DE)

(21) Appl. No.: 11/808,909

(22) Filed: Jun. 13, 2007

Related U.S. Application Data
(63) Continuation of application No. PCT/EP04/14216, filed on Dec. 14, 2004.

(51) Int. Cl. B60L 1/00; H04H 7/00; G06F 7/00; H02G 3/00

(52) U.S. Cl. 307/10.1; 455/3.06; 701/36

(57) ABSTRACT

A system is provided for using at least one mobile terminal in a motor vehicle, particularly a passenger car or a two-wheel vehicle, having the at least one mobile terminal, a display device arranged in the vehicle, an operating device provided in the vehicle, and a communication interface between the motor vehicle and the mobile terminal. A first software integration device is provided in the motor vehicle, which detects a mobile terminal situated in the vehicle, and/or a second software integration device is provided in the mobile terminal, which detects a motor vehicle situated in the vicinity of the mobile terminal. A software application present at the mobile terminal is determined. The downloading of a software integration application is carried out via a communication connection by way of a vehicle-internal and/or vehicle-external downloading device, and the software application that was determined to exist the mobile terminal is provided, by way of the downloaded software integration application, for use in the motor vehicle by utilizing the display device arranged in the motor vehicle and the operating device provided in the motor vehicle.

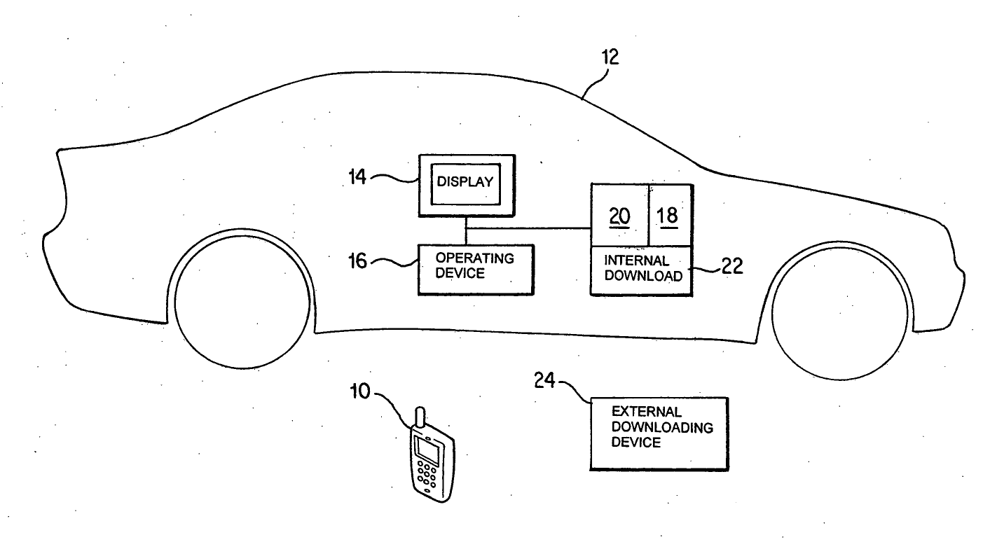

### CROSS-REFERENCE TO RELATED APPLICATIONS

This application is a continuation of PCT International Application No. PCT/EP2004/014216, filed on Dec. 14, 2004, the entire disclosure of which is expressly incorporated by reference herein.

### BACKGROUND AND SUMMARY OF THE INVENTION

The invention relates to a system for using at least one mobile terminal in a motor vehicle, particularly for a passenger car or a two-wheel vehicle, having the at least one mobile terminal, a display device arranged in the vehicle, an operating device provided in the vehicle, and a communication interface between the motor vehicle and the mobile terminal.

The use of a mobile telephone is known, which communicates with the vehicle by way of the Bluetooth short-range radio system and by which a telephone conversation is carried out by way of the handsfree system of the vehicle. A so-called “mobile integration unit” of the vehicle accesses the telephone numbers of the mobile telephone and permits their display on a display device of the vehicle. An operating device of the man-machine interface of the vehicle permits the dialing of the telephone numbers stored in the mobile telephone. The menu design and the menu mode on the display installed in the vehicle is determined by a sequence control or program control present in the vehicle.

It is an object of the present invention to provide an improved system for using mobile terminals in a motor vehicle.

This object is achieved by providing a system, particularly for a passenger car or a two-wheel vehicle, having the at least one mobile terminal, a display device arranged in the vehicle, an operating device provided in the vehicle, and a communication interface between the motor vehicle and the mobile terminal. A first software integration device is provided in the motor vehicle, which detects a mobile terminal situated in the vehicle, and/or a second software integration device is provided in the mobile terminal, which detects a motor vehicle situated in the proximity thereof. A software application present at the mobile terminal is determined. The downloading of a software integration application is carried out by way of a communication connection by a vehicle-internal and/or vehicle-external downloading device, and the software application existing at the mobile terminal is provided by way of the downloaded software integration application for use in the motor vehicle by utilizing the display device arranged in the motor vehicle and the operating device provided in the motor vehicle. Advantageous further developments are described and claimed herein.

According to the invention, a software integration device is provided in the motor vehicle and/or in the mobile terminal, which software integration device detects a mobile terminal situated in the vehicle. Alternatively or additionally, in the mobile terminal device, a second software integration device is provided, which detects a motor vehicle situated in the proximity thereof. A software application present on the mobile terminal is determined. A software integration application is downloaded by way of a communication connection by a vehicle-internal and/or vehicle-external downloading device. The software application present on the mobile terminal is provided by way of the downloaded software integration application for use in the motor vehicle by using the display device arranged in the motor vehicle and the operating device provided in the motor vehicle.

The first and second software integration devices according to the invention, respectively, and the software integration application according to the invention, permit a largely automatic integration of the mobile terminal and of its software applications, so that the latter can ergonomically be used in the vehicle by way of an operating device present in the motor vehicle and a display device provided in the motor vehicle.

Other objects, advantages and novel features of the present invention will become apparent from the following detailed description of the invention when considered in conjunction with the accompanying drawings.

### BRIEF DESCRIPTION OF THE DRAWING

The FIGURE is a schematic block diagram illustrating components of the system according to the present invention.

### DETAILED DESCRIPTION OF THE PREFERRED EMBODIMENTS

Referring to the FIGURE, the system for using at least one mobile terminal 10 in a motor vehicle 12 is shown. The motor vehicle 12 includes a display device 14 arranged in the vehicle, an operating device 16 for use by an occupant of the vehicle, as well as a communication interface 18 for communicating between the motor vehicle 12 and the mobile terminal 10. A software integration device 20 is provided in the motor vehicle, which device 20 detects a mobile terminal that is situated in the vehicle. Another software integration device may be provided in the mobile terminal 10, which device detects when it is in the proximity of the motor vehicle. A vehicle-internal downloading device 22 and/or a vehicle-external downloading device 24 is operated to download a software integration application. The system determines a software application that is present at the mobile terminal 10, and downloads the software application for use in the motor vehicle via the downloaded software integration application by utilizing the operating device 16 and display device 14 arranged in the vehicle.

In an embodiment of the invention, the mobile terminal is a mobile telephone, a PDA or personal digital assistant, a notebook or another mobile computer, such as in particular a mobile entertainment device.

In a preferred embodiment of the invention, the mobile terminal communicates with the terminal's integration device according to the invention by way of an Internet protocol (IP protocol).

In a further development of the invention, the software application present on the mobile terminal will be determined only when the driver of the vehicle has authorized the system according to the invention to do so by a manual and/or acoustic release. The authorization process preferably takes place by using the display device arranged in the vehicle and/or by using the operating device provided in the vehicle.

In a further development of the invention, the vehicle-internal downloading device is a data memory present in the motor vehicle, such as, in particular, a visual data memory, preferably a DVD, or a semiconductor memory. As a result, large quantities of data can be moved into the motor vehicle in an easy and cost-effective manner by using a corresponding reading device, and the suitable software application can be made available to a plurality of mobile terminals and/or software applications.

In an embodiment of the invention, the vehicle-external downloading device is operated by the manufacturer or on behalf of the manufacturer of the corresponding motor vehicle. As a result, it can be ensured that only compatible software integration applications and/or software applications not endangering the safety of the vehicle are transferred, which, in addition, are always in an updated state.

In a further development of the invention, the software integration device causes or controls the vehicle-internal and/or vehicle-external downloading of the software integration application. Together with the preferred measure that the software integration device is installed in the vehicle, considerable safety is achieved with respect to a software and/or hardware manipulation on the vehicle electronic system, which could otherwise threaten the safety of the vehicle.

In an embodiment of the invention, the software integration application to be downloaded is first determined. As an alternative or in addition, the software integration application, that is to be downloaded is stored at the mobile terminal. The mobile terminal preferably transfers this information to the driver's PC or notebook. The PC or the notebook downloads the software integration application from a vehicle-external downloading device and transfers it to the mobile terminal, and the mobile terminal then provides the software integration application in the motor vehicle. The PC or the notebook is situated outside the vehicle, preferably in the home environment of the driver of the motor vehicle, and the downloading takes place by way of an Internet connection, such as in particular a broadband Internet connection. It is understood, that the mobile terminal can also carry out the downloading directly from the vehicle when a suitable data connection, particularly a broadband Internet connection, is provided by the vehicle. Likewise, the mobile terminal can carry out the downloading in the driver's home environment when a suitable data connection, particularly a broadband data connection, is provided there for the download.

In another embodiment of the invention, the downloaded software integration application is completely or partially stored and/or installed in the mobile terminal. As a result, the software application according to the invention can be used in the motor vehicle by utilizing the display device arranged in the motor vehicle and the operating device provided in the motor vehicle.

In an alternative or supplementary embodiment of the invention, the downloaded software integration application is completely or partially stored and/or installed in the software integration device. As a result, the software application can be used in the motor vehicle by utilizing the display device arranged in the motor vehicle and the operating device provided in the motor vehicle.

In an embodiment of the invention, a first driver software for operating the display device arranged in the vehicle is stored and/or installed in the software integration device and/or in the mobile terminal. As an alternative or in addition, a second driver software is stored and/or installed in the embodiment for operating the operating device provided in the vehicle. As a result of this measure, particularly the linkage” of the software applications installed at the mobile terminal to the vehicle is simplified.

In a further development of the invention, the software integration device has an unambiguous identification information and/or an unambiguous Internet address or an unambiguous IP address. The software integration device can thereby be determined and/or be reached via the Internet or be addressed in an unambiguous manner. This permits particularly the updating of the software stored or installed in the vehicle and/or in the software integration devices for the purpose of maintenance or repair.

In a further development of the invention, the software integration device is completely or partially controlled by way of a software integration device operating software provided in the software integration device. The software integration device is preferably designed such that the software stored and/or installed in the software integration device can be exchanged or updated by means of newer software. The software integration device operating software according to the invention particularly permits an access control to the vehicle from the outside by way of a telecommunication connection, particularly by way of an Internet connection. In particular, the construction of a firewall between the vehicle and the Internet is thereby permitted.

In another embodiment of the invention, a software application stored and/or installed in the software integration device is updated by way of the vehicle-internal downloading device, by way of the vehicle-external downloading device, and/or by way of software stored at the mobile terminal. As a result, the downloading can be updated in a time-controlled and/or event- controlled manner by the software stored at the mobile terminal. For example, information concerning an available software update can be transmitted into the vehicle, which software update is downloaded from the mobile terminal and/or from the software integration device at a predetermined time, which may be indicated in the information, by the vehicle-external downloading device. Furthermore, by means of the software application, an authorization check of the access and/or an authentication check of the software provided for the updating can be carried out before the updating.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for using a mobile terminal in a motor vehicle, comprising:
a display device arranged in the vehicle;
an operating device arranged in the vehicle;
a communication interface between the motor vehicle and the mobile terminal;
at least one of a first software integration device provided in the motor vehicle for detecting when the mobile terminal is situated in the vehicle and a second software integration device provided in the mobile terminal for detecting when a motor vehicle is in proximity to the mobile terminal;
at least one of a vehicle-internal and vehicle-external downloading device, a downloading of a software integration application being performed via a communication connection by way of the at least one of the vehicle-internal and vehicle-external downloading device; and
wherein a software application is determined to be present at the mobile terminal, and is provided by way of the download software integration application for use in the motor vehicle by utilizing the display device and the operating device arranged in the motor vehicle.

2. The system according to claim 1, wherein the mobile terminal is one of: a mobile telephone, a personal digital assistant, a notebook, another mobile computer, and a mobile entertainment device.

3. The system according to claim 1, wherein the mobile terminal communicates with at least one of the first and second software integration device by way of an Internet Protocol.

4. The system according to claim 2, wherein the mobile terminal communicates with at least one of the first and second software integration device by way of an Internet Protocol.

5. The system according to claim 1, wherein the software application present on the mobile terminal is determined only when a driver of the vehicle has provided an authorization by at least one of a manual and acoustic release, the authorization taking place by using at least one of the display device and the operating device arranged in the vehicle.

6. The system according to claim 1, wherein the vehicle-internal downloading device is a data memory present in the motor vehicle.

7. The system according to claim 6, wherein the data memory is one of: a DVD and semiconductor memory.

8. The system according to claim 1, wherein the vehicle-external downloading device is operatively configured for operation by one of: a manufacturer and on behalf of a manufacturer, of the motor vehicle.

9. The system according to claim 1, wherein the software integration device causes the vehicle-internal and/or vehicle-external downloading of the software integration application.

10. The system according to claim 1, wherein the software integration application to be downloaded is at least one of determined and an identity thereof stored at the mobile terminal, and further wherein the mobile terminal, as required, transfers the software integration application or identity thereof to a driver's computer, which computer outside the vehicle by way of an Internet connection downloads the software integration application from a vehicle-external downloading device and transfers it to the mobile terminal, the mobile terminal then providing the software integration application in the motor vehicle.

11. The system according to claim 1, wherein the downloaded software integration application is completely or partially stored and/or installed in the mobile terminal, whereby the software application is usable in the motor vehicle by utilizing the display device and the operating device arranged in the motor vehicle.

12. The system according to claim 1, wherein the downloaded software integration application is completely or partially stored and/or installed in the software integration device, whereby the software application is usable in the motor vehicle by utilizing the display device and the operating device arranged in the motor vehicle.

13. The system according to claim 1, wherein at least one of a first driver software for operating the display device arranged in the vehicle is provided in at least one of the software integration device and the mobile terminal, and a second driver software is provided for operating the operating device arranged in the vehicle.

14. The system according to claim 1, wherein the software integration device has an at least one of unambiguous identification information, an unambiguous Internet address, and an unambiguous IP address.

15. The system according to claim 1, wherein the software integration device is completely or partially controlled by way of a software integration device operating software provided in the software integration device, the software integration device being designed such that the software stored and/or installed in the software integration device is exchangeable or updateable for newer software.

16. The system according to claim 1, wherein a software application stored and/or installed in the software integration device is updated by way of at least one of the vehicle-internal downloading device, the vehicle-external downloading device, and software stored at the mobile terminal.

17. A method for using a software application in a motor vehicle, the method comprising the acts of:
detecting at least one of a mobile terminal situated in the motor vehicle via a first software integration device arranged in the vehicle, and a motor vehicle situated in proximity to the mobile terminal via a second software integration device arranged in the mobile terminal;
determining a particular software application present at the mobile terminal;
utilizing a communication connection to download a software integration application via one of a vehicle-internal and vehicle-external downloading device; and
utilizing an operating device and display device fixedly arranged in the motor vehicle to operate the software application by way of the downloaded software integration application.
